(19) United States
(12) Patent Application Publication
(10) Pub. No.: US 2012/0023586 A1
(43) Pub. Date: Jan. 26, 2012

(54) DETERMINING PRIVACY RISK FOR DATABASE QUERIES

(75) Inventors: MYRON D. FLICKNER, San Jose, CA (US); Tyrone W. Grandison, San Jose, CA (US)

(73) Assignee: International Business Machines Corporation, Armonk, NY (US)

(21) Appl. No.: 12/841,573

(22) Filed: Jul. 22, 2010

(51) Int. Cl. G06F 21/00

(52) U.S. Cl. 726/25

(57) ABSTRACT

A system and method for evaluating security exposure of a query includes evaluating a security risk for a query input to a database configured to generate a response to the query. The query has a plurality of attributes and the security risk is evaluated by determining a risk for each of the plurality of attributes and/or determining an exposure consequence based on at least the query. An overall risk is computed based upon attribute risks and consequences. The overall risk is associated and reported with the query.

### BACKGROUND

1. Technical Field

The present invention relates to data security and more particularly to systems and methods for evaluating privacy risk in data retrieval systems.

2. Description of the Related Art

Information and new analytics are important in making advances for instrumented, interconnected and intelligent systems. How we use this new information is often just as important as the information itself. A balance needs to be determined between availability of information, and privacy concerns of individuals, groups, companies and nations. With the availability of information on-line, concerns with privacy are more prevalent. On-line privacy has developed into a plurality of new businesses. Systems, such as P3P, have enabled on-line businesses to advertise and implement privacy policies for their web channels. While this “channel privacy” is a step forward, a method for measuring privacy at the transaction level is lacking.

### SUMMARY

A system and method for evaluating security exposure of a query includes evaluating a security risk for a query input to a database configured to generate a response to the query. The query has a plurality of attributes, and the security risk is evaluated by determining at least one of a risk severity measure and an exposure consequence for each of the plurality of attributes based on the query. An overall risk is computed based upon all risk severity measures and/or exposure consequences. The overall risk is associated and reported with the query.

A system and method for evaluating security exposure of a query includes evaluating a security risk for a query having a plurality of attributes by determining a sensitivity of a user for each of the plurality of attributes and determining visibility based on the query. An overall risk is computed based upon attribute sensitivities and visibilities. The overall risk is associated and reported with the query.

A system for providing a security risk assessment for a query includes a database configured to store information in computer readable storage media. A query coordinator is configured to receive a query and issue the query to a query processor to generate information for executing a query search. A privacy risk evaluator is coupled to the query coordinator. The privacy risk evaluator is configured to concurrently receive the query issued from the query coordinator, compute a risk assessment associated with the query and return the risk assessment along with query results.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for evaluating and reporting privacy risk associated with a query in accordance with one illustrative embodiment;

FIG. 2 is a block/flow diagram showing a system/method for executing a privacy risk evaluator in accordance with one illustrative embodiment;

FIG. 3 is a block/flow diagram showing a system/method for evaluating and reporting privacy risk associated with a query in accordance with another illustrative embodiment; and

FIG. 4 is a block/flow diagram showing another illustrative system/method for evaluating and reporting privacy risk associated with a query in accordance with yet another illustrative embodiment.

### DETAILED DESCRIPTION OF PREFERRED EMBODIMENTS

In accordance with the present principles, systems and methods are provided that measure privacy exposure from a database query by computing a privacy score linked to the database query. Queries with low privacy exposure scores represent minimal privacy exposure whereas queries with high privacy exposure scores represent significant exposure. This enables an automated analysis of applications to identify areas of privacy exposure created and informs users how much privacy they compromise by using the application.

In one embodiment, when issuing a query, a privacy risk score is returned with each result. The system/method is configured to work with current technology, and works on traditional row-store databases, which are relational databases, as well as newer column-store databases. The system/method permits individuals to tune the sensitivity of their data, and is well-suited for database-in-a-cloud deployments.

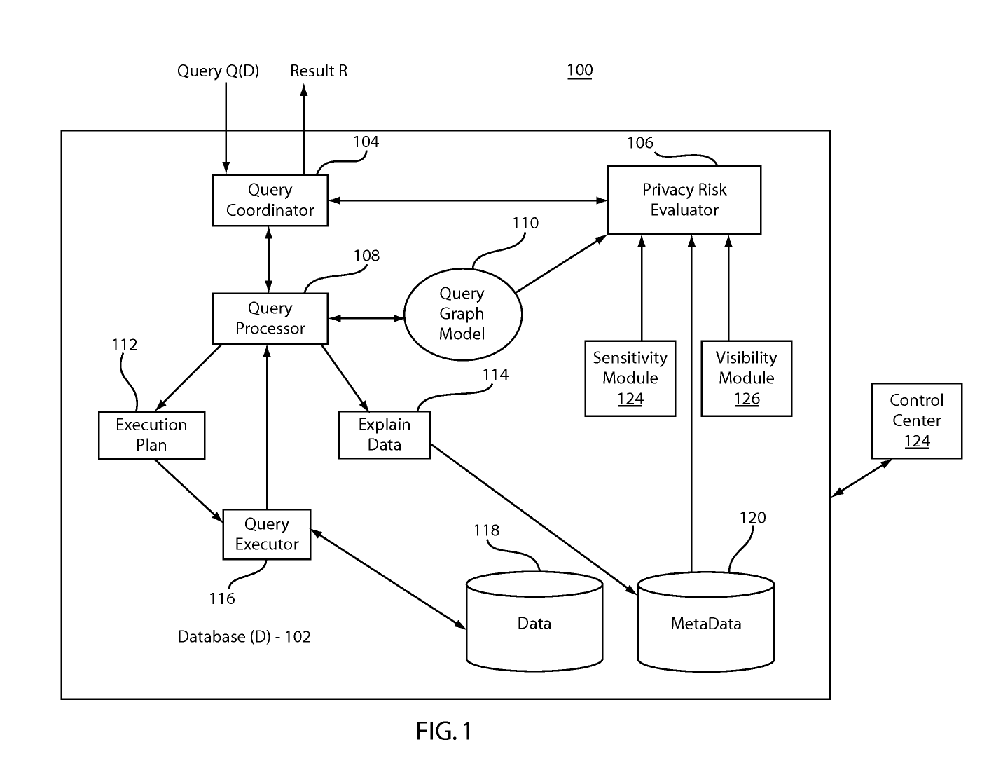

Referring now to the drawings in which like numerals represent the same or similar elements and initially to FIG. 1, an illustrative system/method 100 having a database 102 configured to provide a privacy measure is provided in accordance with one exemplary embodiment. Database 102 may include a column-store or a row-store data system. Database (D) 102 provides a measure of privacy risk exposure, which is returned with the results (result (R)) of an issued query (Q(D)). The system 100 can be used in or with traditional systems, in emerging systems where multi-tenant data stores are provided via Computing Clouds, and in any system where the sensitivity of data becomes an issue.

When a query (Q(D)) is issued, it is sent to a query coordinator 104 which issues the query to a query processor 108. The query processor 108 parses the query, checks the semantics, rewrites the query, performs a pushdown analysis, optimizes an access plan, generates remote SQL (if necessary) and then generates executable code. During this, the query processor 108 creates and uses an abstract representation of the query that is stored in a query graph model 110 and at the end of the processing outputs a (query) execution plan 112 and possibly a series of EXPLAIN data tables 114 (in the case of commercial databases like DB2™). The EXPLAIN data tables 114 are known in the art and provide information and explanation of the execution plan 112 if a user or administrator wants to explore the execution plan. SQL statements may be employed to assist in doing this. When processing EXPLAIN, a special table is filled with the explanations of the execution plan statements. This information may be stored in metadata in metadata storage 120. A query executor 116 executes the execution plan 112 to search data storage 118 to find content that satisfies the query. The query executor 116 reports the query results to the query processor 108, which in turn sends the results to the query coordinator 104.

The query coordinator (QC) 104 and a privacy risk evaluator (PRE) 106 are provided to determine and report query risk. The query coordinator 104 performs several operations. A first operation is to issue the query (and any other auxiliary information provided/needed) to the query processor 108. A second operation is to make a call to the PRE 106 to determine a privacy risk score for the query. The QC 104 preferably makes both calls in parallel so as not to reduce the impact of this new functionality on the query execution time and thus the user's expectations with regard to response time.

Table 1 shows illustrative pseudocode for the QC 104 in accordance with one embodiment.

```
TABLE 1
Results_Structure Query_Coordinator (Query_Structure Query_Data)
{
    pid_t qc_proc = new process; pid_t pre_proc = new process;
    Results_Structure Results = NULL; ResultSet Results_Data =
    NULL; RiskSet Risk_Data = NULL;
```

| | |
|---|---|
| if (qc_proc == 0) | // child process for QC |
| { | |

```
      ‘Results_Data = Query_Processor(Query_Data);
      }
```

| | |
|---|---|
| else if (qc_proc < 0) | // failed to create process |
| { | |

```
        Write error message;
      return NULL;
      }
```

| | |
|---|---|
| if (pre_proc == 0) | // child process for PRE |
| { | |

```
      Risk_Data = Privacy_Risk_Evaluator(Query_Structure);
      }
```

| | |
|---|---|
| else if (pre_proc < 0) | // failed to create process |

```
      {
      Write error message;
      return NULL;
      }
    if (both qc_proc and pre_proc are both finished)
      {
      Results = Results_Data + Risk_Data;
      return Results;
      }
}
```

The pseudo-code above describes the function of the Query Coordinator 104 which issues tasks (child processes) for the query processor 108 and the Privacy Risk Evaluator 106 and returns results. The results include the query results and the risk (or consequence) data (e.g., Results=Results_Data+Risk_Data).

The Privacy Risk Evaluator 106 uses the abstract representation of the issued query, i.e., by using the issued query's id to look up the query graph 110 that is generated from the first stages of the query processor's operations. The notion of a resultset includes data returned from an issued query. We assume a resultset R that emerges from an issued query Q(D). Both are assumed to be described in terms of the rows/columns and tables that they touch.

One embodiment generates both a relative privacy risk score and an absolute privacy risk score. The relative privacy risk score (RltvePRS) measures a risk of privacy exposure based on the tables used in the resultset compared to those in the query, while the absolute privacy risk score (AbsPRS) is the privacy risk based on the tables in the resultset and all the tables in the database 118. Thus:

$$RltvePRS ( Q ( D ) ) = \frac{PRisk ( R )}{PRisk ( Q ( D ) )} \times 100 , AbsPRS ( Q ( D ) ) = \frac{PRisk ( R )}{PRish ( D )} \times 100$$

RltvePRS is the relative Privacy Risk Score (which ranges between 0 and 100, where 0 is low risk and 100 is high risk). AbsPRS is the absolute Privacy Risk Score and PRisk is Privacy Risk of the passed parameter. Privacy risk is a function of the perceived negative impact of a piece of data's exposure (e.g., its sensitivity) and a sphere of exposure that it is exposed to (e.g., its visibility). The more sensitive a piece of the data, the higher its privacy score. The more people a piece of data will be shown to, the higher its privacy score. For example, PRisk(Attributeⱼ)∝Sensitivity(Attributeⱼ), and PRisk(Attributeⱼ)∝Visibility(Attributeⱼ). This is one illustrative example of the parameters employed to determine risk. Other methods and parameters may also be employed. For example, a privacy risk calculation may include a privacy risk score computed using a probability of an attribute disclosure and an impact of the disclosure of that attribute. In another embodiment, a privacy risk score may be computed based upon a frequency of a threat, the threat on an attribute, a cost of that threat. Other parameters and criteria may also be employed.

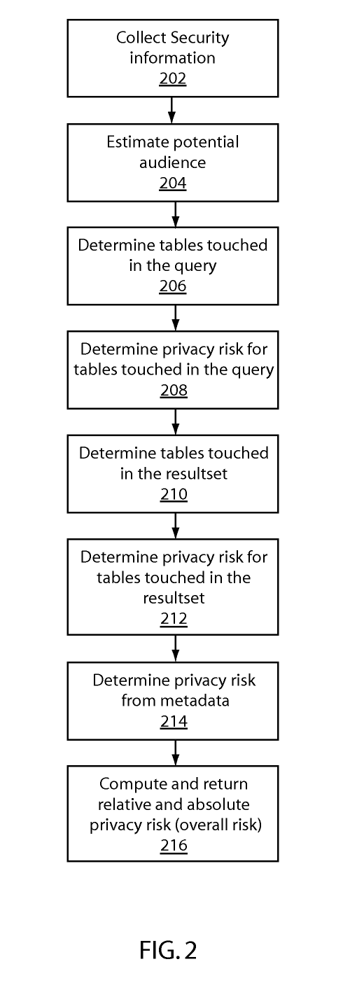

Referring to FIG. 2, the PRE 106 may perform the following operations. In block 202, auxiliary security information is determined or passed with the query. This may include the user id, the user role or position, the device or equipment used to pose the query, etc. In block 204, data from the query, metadata, etc. are employed to estimate the query's potential audience. In block 206, the query graph (110) is employed to determine tables touched in the query. In block 208, the privacy risk is computed by using the tables touched in the query (e.g., associating sensitivity information or other information with the tables touched). In block 210, the query graph (110) is employed to determine the touched tables in the resultset. In block 212, the privacy risk of the touched tables is computed in the resultset (e.g., associating sensitivity information or other information with the tables touched). In block 214, the privacy risk of the database is retrieved from the metadata 120, which includes schema detail and other semantic information on data 118. Schema refers to the underlying organizational structure of the data or conceptual framework used to comprehend data organization. For example, a database includes two tables: Orders and Customers_Purchases. The Orders table may be arranged having two columns: Order ID and Order Description. The Customers_Purchases table may have two columns Customer ID and Order ID. The schema would be Orders (Order Id, Order Description), Customer_purchases (Customer Id, Order Id). The schema describes the organization of the data.

In block 216, compute and then return the relative and absolute privacy risk scores (overall risk) by employing one of a set of mathematical methods for calculating privacy risk. In one embodiment, sensitivity and visibility values for the accessed data is compared to the values for the touched tables.

Referring again to FIG. 1, in one example, the sensitivity values for each column (or row) in a table may be entered by a system administrator via a graphical user interface at a Control Center 122, or the sensitivity values may be automatically calculated by a separate sensitivity module 124 that samples a much larger corpii of data and runs a data mining algorithm to determine the best practices of those people represented therein when it comes to sharing their information. The risk severity/consequence information related to data 118 may be stored in metadata 120.

We will use the terms attribute and column interchangeably and will also use the terms person and tuple interchangeably (as a tuple is a representation of a person's data, in this case). For a row-store database embodiment, we assume a database of tables, where each table is of the form:

| | | | | |
|---|---|---|---|---|
| columnₗ | . . . | . . . | . . . | columnₙ |

personₗ
. . .
. . .
. . .
personₘ

For each column/attribute columnⱼ, there is an associated a risk severity measure or sensitivity metric ∂ⱼ that is bounded within a specific range, e.g., between 0 and 1 (0 being the least sensitive and 1 being the most sensitive). Such metrics are associated with data (or schema, etc.) and stored in metadata 120 or other memory storage. As each person may have their own individual or personalized perceptions of which attributes are currently more sensitive than others, a user may be provided with a mechanism to tailor/modify their views on what is sensitive or not. To model this, the concept of the person's attribute subjectivity factor λᵢⱼ (for personᵢ and columnⱼ) is introduced. This factor is also assumed to be in an arbitrary range (e.g., 0 to 10).

The sensitivity of a person's attributeⱼ is ∂ⱼ [symbol] λᵢⱼ. The sensitivity of a table T, (sen(T)) is ∪ⱼ₌₁^{m}∪ᵢ₌₁ⁿ∂ⱼ [symbol] λᵢⱼ. The sensitivity for the entire database (sen(D)) is

$${⋃}_{T ∈ D} sen ( T ) .$$

∪ is an arbitrary operator that is additive. [symbol] is an arbitrary operator that is multiplicative and that maps the resultant value back into the range for the sensitivity metric (which is between 0 and 1 in the example above).

The visibility or consequence of the query results, ω(Q(D)), is indicated by a policy in place that governs the query access. The policy may be set in a visibility module 126 that supports operations of the PRE 106. Given the query issuer's id (and/or role, purpose, etc.), which can be either inferred from the database's metadata (120) and/or passed to the PRE 106 as auxiliary query information, the PRE 106 maps this information into a measure that quantifies a circle of exposure. The visibility ranges from 1 to 100 (with 1 being only the query issuer and 100 being the known universe of users). The overall risk may be computed based on attribute risks and exposure consequences.

We employ metadata 120 that maps this auxiliary information (e.g., consequences, etc.) into a ranking of visibility measures. For example, a user with a credential role of a computer science department may have a higher visibility number than one with a role of administrator. This metadata 120 may be provided by the database administrator through the control center graphical user interface (GUI) or the like 122. In some embodiments, where visibility information is unavailable, it is assumed to be set to 1.

For example, data retrieved by a nurse for medical operations would receive a higher visibility score than enterprise data retrieved from a cloud by a data entry clerk for that enterprise. Visibility computation may be carried out in accordance with policies, models, formulas, or user selected settings in the visibility module 126. A query may come from a user that has a particular job description, role, security status, etc. The query may include corporate sensitive information, and the query may be asked after business hours. These circumstances can be interpreted and weighted by both the sensitivity module 124 and the visibility module 126 to limit or not limit the sensitivity and the visibility associated with the query. It should be understood that the sensitivity module 124 and the visibility module 126 are provided for illustrative purposes. These modules may be adapted to provide other computations and policies based upon the selected criteria for computing the risk scores.

In one embodiment, the privacy risk for an entity, E, can now be defined as a combination of the sensitivity and visibility:

$$PRisk ( E ) = ( {∐}_{T ∈ E )} sen ( T ) ) \times ω ( E ) .$$

In one embodiment, E may be instantiated to Q(D), R and D. Here, [symbol] is assumed to be another arbitrary operator that is additive. The same techniques are applicable to both row-store and column-store database embodiments.

While the present embodiments may be employed by a system administrator (e.g., a DB administrator) to determine how much security is needed to protect a particular query to be received at the system by a user, other applications and user types are contemplated. For example, a system may be employed by human resource employees of a business entity, legal staff for security for clients, etc.

Prior to using the present principles to determine risk in a particular database 102, the database needs to be augmented to associate security risk metadata (120) with elements of the schema. For example, a person may have a sensitivity assigned for a given attribute based upon experience; the person may select a sensitivity value; the sensitivity value may be computed using a model or formula; the sensitivity value may be based on models that associate attributes with sensitivity value; etc.

The sensitivity, visibilities, probabilities, costs, threats, etc. may be stored in tables or computed and modified as needed. For example, data analytics methods may be routinely executed on the data 118 or metadata 120 to determine a relative hierarchy of the data items, which can then be used to assign values, within a well-defined range, for an attribute that can be used in privacy risk calculations, e.g., visibility, etc. Metadata may be attached to data content, databases, computer devices or other equipment. The metadata (120) may be employed to weight or otherwise assess the sensitivity and/or the permissible visibility of the data determined with respect to a query.

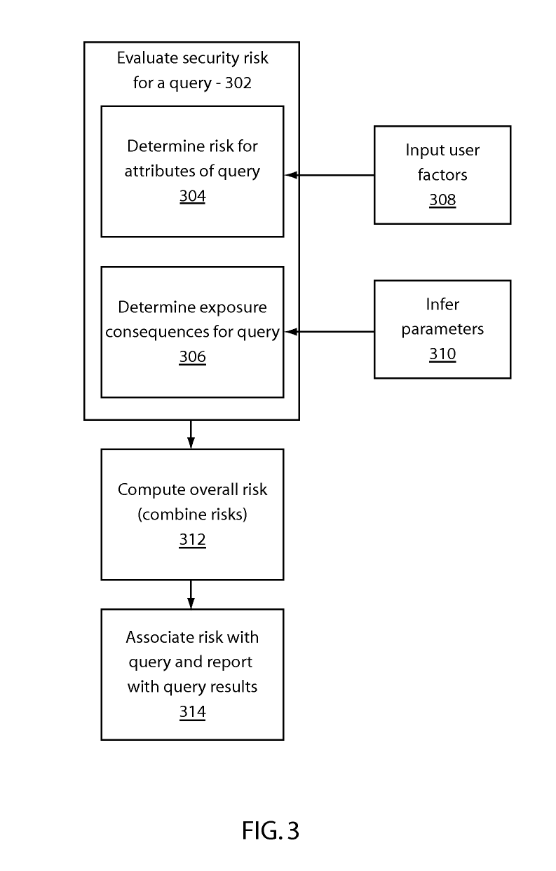

Referring to FIG. 3, a system/method for evaluating security exposure of a query is illustratively shown in accordance with an illustrative embodiment. In block 302, a security risk is evaluated for a query input to a database configured to generate a response to the query. The query has a plurality of attributes. The security risk is evaluated by determining risk parameters, such as, a severity measure or sensitivity, tables touched, etc. for each of the plurality of attributes in block 304. In block 306, exposure consequences or other parameters, e.g., visibility, tables touched in the resultset, etc. are determined based on at least the query. Sensitivity, visibility, probabilities, threats, costs, etc. may be computed using formulas, models, user inputs, policies, metadata associations, lookup tables, experience or historic data, etc.

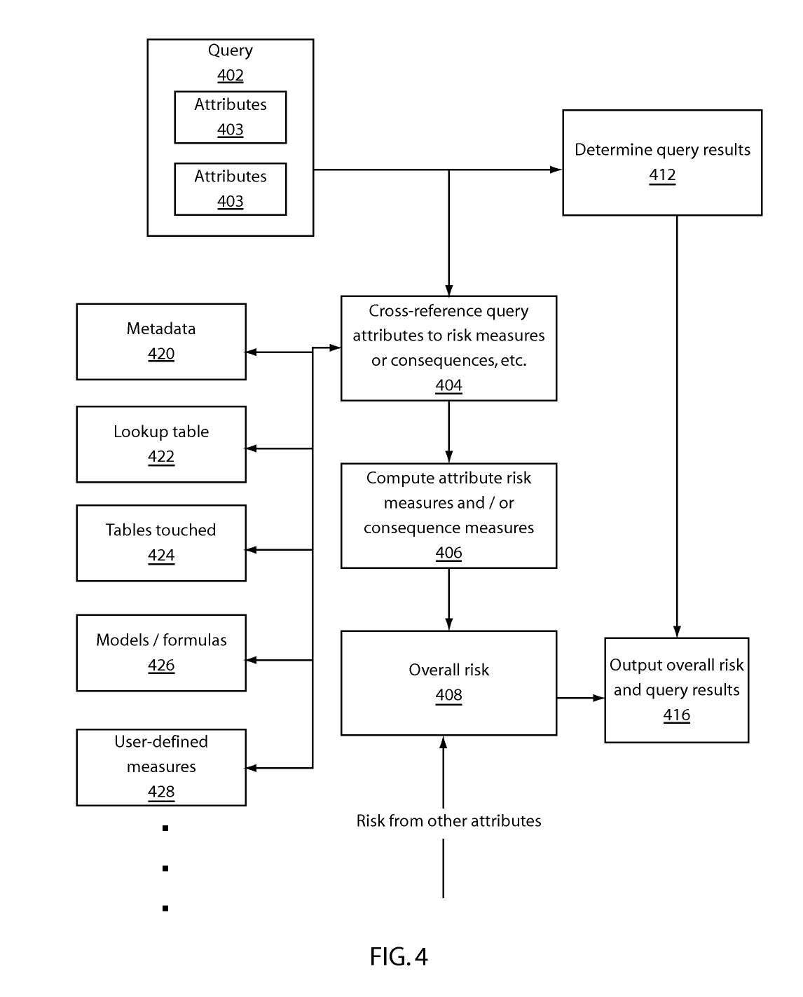

In block 308, user information may be input to subjectively customize the risk evaluation for a particular user or circumstance. In one example, an adjustment factor is employed to account for an individual user's subjective sensitivity. In block 310, query-based parameters may be determined by inferring parameters, such as, e.g., visibility, based upon user characteristics stored in metadata which are mapped into a measure to quantify a circle of exposure, based on policies, based on experience, etc. FIG. 4 shows an illustrative data structure which may be employed to associate risk with a query.

In block 312, an overall risk is computed, e.g., based upon attribute sensitivities and visibilities. In one embodiment, the overall risk also includes a combination of a relative privacy risk score and an absolute privacy risk score. These combinations may also include all attribute risks and exposure consequences from all factors. In block 314, the overall risk is associated and reported with the query. In this way, the query results include a privacy risk score associated therewith. Advantageously, risks associated with transactional level operations are provided.

Referring to FIG. 4, a query 402 includes a plurality of attributes 403. In one embodiment, attributes 403 are cross-referenced to a value or a way of computing a value that assists in defining a security risk for that attribute in block 404. The value may be stored in metadata 420 and assigned in advance or computed for a given schema, data content, etc. The value may be looked up in a specific lookup table or other reference 422. The value may be computed based upon the tables touched 424 in satisfying the query or in the resultset for the query. Model or formulas 426 may be provided to compute the value based upon current conditions (e.g., time of day, person querying, threat level, etc.). User-defined measures 428 may be employed (e.g., a user defines which data is most sensitive, etc.). The value is any parameter that may be employed in computing an attribute risk in block 406, such as, e.g., sensitivity, threat, exposure, etc. In block 408, an overall risk is determined by a form of an add operation. Different types of risk may also be combined depending on the risk evaluation method or policy employed. The overall risk may include all of the risk from other attributes as well.

in block 412, query results are concurrently determined with the risk assessments. Tables touched in block 424 will gather input from block 412 as the query is resolved. In block 416, the overall risk is output with the query results.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described preferred embodiments of a system and method for determining privacy risk for database queries (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for evaluating security exposure of a query, comprising:
evaluating a security risk for a query input to a database configured to generate a response to the query, the query having a plurality of attributes and the security risk being evaluated by determining at least one of a risk severity measure and an exposure consequence for each of the plurality of attributes based on the query;
computing an overall risk based upon all risk severity measures and/or exposure consequences; and
associating and reporting the overall risk with the query.

2. The method as recited in claim 1, wherein determining a risk severity measure includes at least one of:
computing a sensitivity based upon a sensitivity model or formula;
looking up a sensitivity for an attribute using a sensitivity lookup table; and
assigning a sensitivity for an attribute using experience or historic data.

3. The method as recited in claim 1, wherein determining a risk severity measure includes computing a probability.

4. The method as recited in claim 1, wherein determining an exposure consequence includes determining a visibility.

5. The method as recited in claim 1, wherein determining a risk severity measure includes selecting a sensitivity by a user.

6. The method as recited in claim 1, wherein determining a risk severity measure includes selecting an adjustment factor to account for an individual user's subjective sensitivity.

7. The method as recited in claim 1, wherein evaluating a security risk includes a combination of a relative privacy risk score and an absolute privacy risk score.

8. The method as recited in claim 1, wherein determining an exposure consequence includes inferring visibility based upon user characteristics stored in metadata which are mapped into a measure to quantify a circle of exposure.

9. A computer readable storage medium comprising a computer readable program for evaluating security exposure of a query, wherein the computer readable program when executed on a computer causes the computer to perform the steps of:
evaluating a security risk for a query input to a database configured to generate a response to the query, the query having a plurality of attributes and the security risk being evaluated by determining at least one of a risk severity measure and an exposure consequence for each of the plurality of attributes based on the query;
computing an overall risk based upon all risk severity measures and/or exposure consequences; and
associating and reporting the overall risk with the query.

10. The computer readable storage medium as recited in claim 9, wherein determining a risk severity measure includes at least one of:
computing a sensitivity based upon a sensitivity model or formula;
looking up a sensitivity for an attribute using a sensitivity lookup table; and
assigning a sensitivity for an attribute using experience or historic data.

11. The computer readable storage medium as recited in claim 9, wherein determining a risk severity measure includes computing a probability.

12. The computer readable storage medium as recited in claim 9, wherein determining an exposure consequence includes determining a visibility.

13. The computer readable storage medium as recited in claim 9, wherein determining a risk severity measure includes selecting a sensitivity by a user.

14. The computer readable storage medium as recited in claim 9, wherein determining a risk severity measure includes selecting an adjustment factor to account for an individual user's subjective sensitivity.

15. The computer readable storage medium as recited in claim 9, wherein evaluating a security risk includes a combination of a relative privacy risk score and an absolute privacy risk score.

16. The computer readable storage medium as recited in claim 9, wherein determining an exposure consequence includes inferring visibility based upon user characteristics stored in metadata which are mapped into a measure to quantify a circle of exposure.

17. A system for providing a security risk assessment for a query, comprising:
a database configured to store information in computer readable storage media;
a query coordinator configured to receive a query and issue the query to a query processor to generate information for executing a query search; and
a privacy risk evaluator coupled to the query coordinator, the privacy risk evaluator configured to concurrently receive the query issued from the query coordinator, the privacy risk evaluator configured to compute a risk assessment associated with the query and return the risk assessment along with query results.

18. The system as recited in claim 17, further comprising metadata associated with searchable data stored in memory storage, the metadata indicating information for computing a risk score for the query.

19. The system as recited in claim 17, further comprising a sensitivity module coupled to the privacy risk evaluator to provide user specific information for computing a risk score; and a visibility module coupled to the privacy risk evaluator to provide visibility policies for computing a risk score.

20. The system as recited in claim 17, wherein the risk assessment includes a combination of a relative privacy risk score and an absolute privacy risk score.
